(19) United States
(12) Patent Application Publication
(10) Pub. No.: US 2023/0035178 A1
(43) Pub. Date: Feb. 2, 2023

(54) High Acoustic and Low Density Basemat

(71) Applicant: USG INTERIORS, LLC, Chicago, IL (US)

(72) Inventors: Yufeng Xu, Gurnee, IL (US); Bangji Cao, Naperville, IL (US); William Frank, Lake Villa, IL (US); Qing C. Yu, Libertyville, IL (US); Louis P. Stocco, Western Springs, IL (US); Adam Warren Keller, Grayslake, IL (US)

(73) Assignee: USG INTERIORS, LLC, Chicago, IL (US)

(21) Appl. No.: 17/443,319

(22) Filed: Jul. 23, 2021

(51) Int. Cl. C04B 14/46; C04B 28/14; C04B 14/18; C04B 18/24; B32B 19/06; B32B 5/02

(52) U.S. Cl. CPC C04B 14/46; C04B 28/14; C04B 14/18; C04B 18/241; B32B 19/06; B32B 5/022; C04B 2111/00629

(57) ABSTRACT

The disclosure provides basemats for fibrous panels, including a mineral wool present in an amount of at least about 60 wt %, based on the total weight of the basemat, a mineral filler, a cellulose present in an amount of about 1 wt % to about 3 wt %, based on the total weight of the basemat, and a binder. The basemat has a backing side and a facing side. Also provided are fibrous panels including the basemat of the disclosure and a porous veil.

### BACKGROUND

### Field of the Invention

The invention relates generally to basemats for fibrous panels. More specifically, the invention relates to a basemat for a fibrous panel comprising a mineral wool, a mineral filler, a cellulose, and a binder.

### BRIEF DESCRIPTION OF RELATED TECHNOLOGY

Fibrous panels, such as ceiling tiles or acoustical panels, are generally laminated structures comprising a basemat and a non-woven glass or glass blended veil.

Water-felting of dilute aqueous dispersions of mineral wool and lightweight aggregate is a well-known commercial process for manufacturing basemats. In this process, an aqueous slurry is flowed onto a moving foraminous support wire, such as that of a Fourdinier or Oliver mat forming machine, for dewatering. The slurry may be first dewatered by gravity and then dewatered by vacuum suction means to form a wet basemat. The wet basemat may then be dewatered by pressing (with or without the application of additional vacuum) to the desired thickness between rolls and a support wire to remove additional water. The wet basemat may then be dried in heated convection drying ovens and the dried material is cut to the desired dimensions to produce the basemat, fissured and/or perforated to impart acoustical absorbency, laminated with a veil, and optionally face coated, such as with paint, to produce acoustical tiles and panels. Drying in the heated convection drying oven typically is the production limiting step, as well as the most costly production step.

The water holding value of a fibrous panel relates to the amount of water retained after dewatering the slurry. The higher the water holding value, the more water that must be removed during drying to form the fibrous panel. From a production cost standpoint, a wet basemat with relatively lower density typically uses less mineral wool and is easier and less costly to dry. Attempts to reduce density of the basemat to less than 12 pounds per cubic feet (pcf), however, have been found to provide a basemat that often cannot survive the drying process due to its reduced wet strength. Typically, the basemat was observed breaking during the conveying and drying processes, potentially causing destruction of the kiln and creating waste. Additionally, the slurry used to prepare the basemat was observed falling through the rollers used during manufacture, causing delay and resulting in unusable basemats. As a result of these failures, production of basemats with densities less than 12 pounds per cubic foot has generally been avoided.

### SUMMARY

In one aspect, the disclosure provides a basemat for a fibrous panel, comprising a mineral wool present in an amount of at least about 60 wt %, based on the total weight of the basemat, a mineral filler, a cellulose present in an amount of about 1 wt % to about 3 wt %, based on the total weight of the basemat; and, a binder, wherein the basemat has a backing side and a facing side.

In another aspect, the disclosure provides a fibrous panel comprising the basemat of the disclosure and a porous veil having a first surface and a second surface, wherein the first surface is in contact with the facing side of the basemat.

Further aspects and advantages will be apparent to those of ordinary skill in the art from a review of the following detailed description. While the methods and compositions are susceptible of embodiments in various forms, the description hereafter includes specific embodiments with the understanding that the disclosure is illustrative, and is not intended to limit the disclosure to the specific embodiments described herein.

### DETAILED DESCRIPTION

Advantageously, the basemats of the disclosure can be used to provide fibrous panels having a high noise reduction (NRC) and a high ceiling attenuation class (CAC) rating while also having a decreased density (relative to density values for conventional high NRC and high CAC basemats), surprisingly, achieving such advantageous acoustic performance even without perforating the basemats. The disclosure provides basemats for fibrous panels having a decreased density that also demonstrate acceptable strength. For example, the disclosure provides basemats that demonstrate sufficient wet strength such that the basemats consistently survive the conveying and drying processes during production, despite having significantly lower densities (at least relative to conventional high NRC and high CAC basemats). Moreover, the basemats of the disclosure are easily processed as shown, for example, by the cuttability of the dried basemats. Reduced density will result in reduced material use and reduced production costs. Significant energy savings may also be realized because of reduced temperatures and/or drying times in the heated convection oven.

In particular, the present inventors advantageously found that incorporating small amounts of cellulosic fibers (e.g., about 1 wt % to about 3 wt % paper fiber) into the basemat composition surprisingly allowed for the production of a low density basemat having sufficient wet strength to survive water-felting processing at significantly reduced cost and without negatively affecting processability and performance properties such as wet strength, cuttability, NRC, and CAC, surprisingly, even without perforating the basemats. Of course, the basemats may also be optionally perforated, if desired, but such perforation is not needed to achieve the high acoustic properties desired by consumers.

As used herein, the term “about” means+/−10% of any recited value, or in an alternative embodiment, +/−5% of any recited value. As used herein, this term modifies any recited value, range of values, or endpoints of one or more ranges.

### Basemats

The basemats of the disclosure include a mineral wool, a mineral filler, a cellulose, and a binder. The basemats have a backing side and a facing side.

As provided herein, the basemats include a mineral wool. As used herein, the terms “mineral wool” and “wool” should be considered interchangeable. Mineral wool is comprised of fibers of inorganic raw materials. Mineral wool is a term broadly applied to various related vitreous products. In general, mineral wool is a fiberglass-like material composed of very fine, interlaced mineral fibers, somewhat similar in appearance to loose wool. It is composed primarily of silicates of calcium and aluminum, chromium, titanium, and zirconium. Typically, mineral wool is produced from natural rock or slag. Slag is a term broadly applied to refer to waste products of the primary metal and foundry industries, including deposits from the furnace lining charge impurities, ash from fuel, and fluxes used to clean the furnace and remove impurities. Generally speaking, although mineral fibers have an appearance that is similar to that of glass fibers, their chemical composition is significantly different than that of glass fibers due to the high content of iron, calcium, and magnesium and a relatively low proportion of silicon dioxide and aluminum.

The mineral wool may be of any of the conventional mineral fibers prepared from basalt, slag, granite, or other vitreous mineral constituent. Expressed in terms of percent by weight of the total dry solids content of the final basemat product, the mineral wool constituent may be present in an amount of at least 60 wt %. Thus, herein, the amounts of components in the basemat are provided on a dry weight basis of the final basemat (e.g., following dewetting and/or drying), unless specifically reported otherwise. For example, the mineral wool can be provided in an amount of at least about 60 wt. %, at least about 65 wt. %, at least about 70 wt. %, at least about 75 wt. %, or at least about 80 wt % and/or up to about 70 wt. %, up to about 75 wt. %, up to about 80 wt. %, up to about 85 wt. %, up to about 90 wt. %, or up to about 95 wt %, based on the total weight of the basemat, The mineral wool may be provided in an amount of about 60 wt % to about 95 wt %, about 60 wt % to about 90 wt %, about 60 wt % to about 80 wt %, about 65 wt % to about 80 wt %, about 65 wt % to about 75 wt %, or about 60 wt % to about 75 wt %, based on the total weight of the basemat. In embodiments, the mineral wool is present in an amount of about 65 wt % to about 95 wt %, based on the total weight of the basemat.

The basemats further include a mineral filler. The terms “mineral filler” and “filler” should be considered interchangeable. As understood by one of ordinary skill in the art, mineral wool and mineral fillers are distinct components of the slurry, each of which is necessary to form a basemat. Suitable examples of mineral fillers include, but are not limited to, clay, perlite, vermiculite, and combinations thereof. In embodiments, the mineral filler is free of glass beads. In embodiments, the mineral filler includes perlite, such as expanded perlite.

Generally, the mineral filler can be present in an amount of about 5 wt % to about 25 wt %, based on the total weight of the basemat. For example, the mineral filler can be included in an amount of at least about 5 wt %, at least about 8 wt %, at least about 10 wt %, at least about 12 wt %, at least about 15 wt %, at least about 17 wt % or at least about 20 wt % and/or up to about 10 wt %, up to about 12 wt %, up to about 15 wt %, up to about 17 wt %, up to about 20 wt %, up to about 22 wt %, or up to about 25 wt %, such as about 5 wt % to about 25 wt %, about 5 wt % to about 22 wt %, about 10 wt % to about 20 wt %, about 8 wt % to about 15 wt %, about 8 wt % to about 12 wt %, about 12 wt % to about 17 wt %, or about 15 wt % to about 20 wt %.

The basemats of the disclosure include a cellulose. Cellulose, or cellulosic fiber, is an example of an organic fiber which provides structural elements to the final basemat. Cellulosic fibers are typically provided as paper fibers using recycled newsprint. Over Issued Newspaper (01N) and Old Magazine (OMG) may be used in addition to, or as an alternative, to recycled newsprint. The paper fiber is present in an amount of about 1 wt % to about 3 wt % cellulose, for example, about 1 wt %, about 1.5 wt. % about 2 wt. %, about 2.5 wt. %, such as from 1.5 wt. % to about 3.0 wt. %. Surprisingly, when the cellulose is present in amount greater than about 1 wt %, the basemat has sufficient wet strength to survive dewetting and drying that are conducted during water-felting basemat manufacturing using a Fourdinier-type mat forming apparatus, while continuing to demonstrate acceptable cuttability.

The basemats of the disclosure include a binder. Examples of suitable binders include, but are not limited to, starches, latex, reconstituted paper products, and combinations thereof. In embodiments, the binder is chosen from one or more binders in the group of a starch, a latex, and a reconstituted paper product. In embodiments, the binder includes a starch and a latex.

The binder can be present in a total amount of about 5 wt % to about 20 wt %, based on the total weight of the basemat. For example, the binder can be present in a total amount of at least about 5 wt %, at least about 8 wt %, at least about 10 wt %, at least about 12 wt %, at least about 15 wt %, or at least about 17 wt % and/or up to about 12 wt %, up to about 15 wt %, up to about 17 wt %, or up to about 20 wt %, based on the total weight of the basemat. For example, the binder may be provided in an amount of about 5 wt % to about 20 wt %, about 5 wt % to about 15 wt %, about 8 wt % to about 17 wt %, about 8 wt % to about 15 wt %, about 12 wt % to about 15 wt %, or about 15 wt % to about 20 wt %.

In embodiments where the binder includes a starch and a latex, the starch can be present in an amount of about 7 wt % to about 15 wt %, for example, about 10 wt %, and the latex can be present in an amount of about 0.5 wt % to about 4 wt %, for example, about 1 wt %, based on the total weight of the basemat. The starch and the latex can be present in a weight ratio of about 5:1 to about 15:1, for example, about 7:1 to about 15:1, about 7:1 to about 12:1, or about 10:1.

The basemats of the disclosure may optionally include gypsum to promote increased retention and drainage during the conveying and drying processes involved in basemat formation. Gypsum can be present in a total amount of about 0.01 wt % to about 2 wt %, based on the total weight of the basemat. For example, gypsum may be provided in an amount of about 0.25 wt % to about 2.0 wt %, about 0.25 wt % to about 1.75 wt %, or about 0.25 wt % to about 1.5 wt %.

As used herein, the term “low density” refers to a basemat having a density of less than 15 pcf, or lower than 12 pcf. For example the basemat can have a density of less than about 15, 14, 13, 12, 11, 10, 7, or 6 pcf. In embodiments, the basemat has a density between about 7 pcf and 12 pcf, for example, between about 10 pcf and about 12 pcf.

The basemat can have a thickness of about 0.75 inches to about 1.5 inches. For example, the basemat can have a thickness of at least about 0.75, 1.0, or 1.25 inches and/or up to about 1.0, 1.25, or 1.5 inches, such as about 0.75 inches to about 1.5 inches, about 1 inch to about 1.5 inches, about 1 inch to about 1.25 inches, or about 1.25 inches to about 1.5 inches.

In embodiments, the mineral wool is present in an amount of about 65 wt % to about 85 wt %, the mineral filler includes perlite and is present in an amount of about 8 wt % to about 15 wt %, the cellulose includes recycled newsprint paper fiber, and the binder includes starch and latex and is present in an amount of about 8 wt % to about 15 wt %, based on the total weight of the basemat. In such embodiments, the starch and the latex can be present in a weight ratio of about 7:1 to about 12:1.

The basemat can have a wet strength of at least about 1.3 lbf, for example at least about 1.3, about 1.35, about 1.4, about 1.45, about 1.5, about 1.55, or about 1.6. In embodiments, the basemat has a wet strength of about 1.3 lbf to about 1.6 lbf or about 1.35 lbf to about 1.6 lbf. The wet strength of the basemat can be measured using a common tensile test. The tensile test is performed on the basemat after formation but before drying in the oven. The sample is cut to size (about 3″ length), clamped in a universal testing machine, then pulled in tension until broken. The peak load is recorded as the wet strength value.

The basemat can have a maximum cutting load greater than about 9 pound-force foot (lbf), but less than about 10 lbf, for example, about 9, about 9.3, about 9.5, about 9.8, or about 10 lbf. In embodiments, the basemat has a maximum cutting load of about 9 lbf to about 10 lbf, about 9.3 lbf to about 10 lbf, or about 9.3 lbf to about 9.8 lbf. The cutting maximum load can be measured according to the following procedure: a fully formed, dried, and optionally finished (veil, paint, etc) basemat sample is cut to about 3″ length and loaded into a universal testing machine with a cutting jig. The jig uses utility blades commonly used for cutting ceiling tiles during installation. The jig orients the sample and blade for repeatability. The universal testing machine pulls the blade through the sample while recording resistive force. The peak value is recorded as the cutting maximum load.

The basemats can have a cuttability rating of 10. The cuttability rating, measured on a scale of 1 to 10, where 10 is the best rating, is determined by visually inspecting and comparing the cut edge to reference samples. A noticeable visual difference exists between consecutive ratings 10 and 9, in terms of edge roughness after cutting. Higher ratings lead to more uniform production, in terms of both aesthetics and functionality, with less waste.

### Fibrous Panels

The disclosure also provides fibrous panels including the basemats as described herein. The fibrous panels further include a porous veil having a first surface and a second surface, wherein the first surface is in contact with the facing side of the basemat. As used herein, the terms “panel” and “tile” should be considered interchangeable with respect to the disclosed methods inasmuch as the disclosed methods may be correspondingly applied to both forms. Further, as used herein, the term “fibrous panel” includes both “ceiling tiles” and “acoustical tiles.”

Suitable veils and methods for making the same are known in the art. A representative veil composition and procedure for manufacturing the same is described in U.S. Patent Application Publication No. 2005/0181693, which is hereby incorporated herein by reference. In embodiments, the veil includes a porous non-woven fiberglass or fiberglass blended material. The veil may be a non-woven, short or medium strand, continuous fiberglass type material that has a multi-directional and random, overlapping fibrous orientation which allows for significant air permeability and flow in all of its directions. The porous veil can be laminated to the basemat.

The veil is typically very permeable due to including many relatively large pores both in the surface and throughout as a result of using relatively coarse fibers. The veil preferably has suitable porosity to allow airflow and acoustic transmission to the basemat.

In embodiments, the fibrous panel further includes a coating on the second surface of the porous veil. The coating can include a curtain coating and/or a spray coating. In embodiments, the coating includes a curtain coating. In embodiments, the coating includes a spray coating. In embodiments, the coating includes a curtain coating and a spray coating is deposited thereover.

Curtain coating is a process in which a curtain coater creates an uninterrupted, free falling vertical curtain flow of a liquid coating composition from a coating chamber and the liquid coating composition is deposited onto a moving substrate. The substrate is moved on a conveyor through the curtain coater at various speeds. In embodiments, the substrate is a fibrous panel, preferably, a ceiling tile.

The liquid coating composition is first mixed and added into a coating reservoir. In embodiments, the liquid coating composition is an aqueous-based coating composition, comprising water, binder(s), filler(s), and additive(s). In embodiments, the binders are latex polymers. In embodiments, suitable fillers include, but are not limited to, calcium carbonate, titanium dioxide, clay, and the like. In embodiments, the additives can include, but are not limited to, dispersants, water softeners, surfactants (e.g., non-ionic surfactants), biocides, defoamers, thixotropic agents, flow agents, and combinations thereof.

In some embodiments, a liquid coating composition of the invention for application by curtain coating comprises about 30 to about 65 wt % of water, about 1.5 wt % to about 7.5 wt % of binder, specifically, a latex polymer binder, about 30 wt % to about 65 wt % of filler, and about 0.01 to about 10 wt % of additives. Coating composition components are described by mass of solids where applicable (thus, in the aforementioned liquid coating composition, the latex polymer component is expressed as solids only, and any water that may be present is included with the water component).

Coat weight is a measurement of the amount of coating added the substrate. The coat weight can be controlled by adjusting the speed of the conveyor and/or adjusting the size of a slot opening of the curtain coating head which may be pressurized as is known in the art. In embodiments, the coat weight of the coating composition deposited by curtain coating is from about 5 g/ft² to about 25 g/ft², preferably from about 8 g/ft² to about 22 g/ft², and more preferably from about 10 g/ft² to about 18 g/ft². Coat weight for a specific coating process can be measured by passing a substrate of known area and weight through the coating equipment in the same manner as a ceiling tile, with the wet weight of the substrate directly after coating being compared to the (dry, uncoated) weight of the substrate prior to coating. Coat weight is reported as the difference in weight (between the wet substrate weight and the uncoated substrate weight) divided by the surface area of the substrate. Thus, for a specific fibrous panel, coat weight can be determined by subtracting the weight of the combination of the basemat and veil laminated to the basemat from the weight of the coated basemat and veil laminated to the basement, and dividing by the surface area of face side of the fibrous panel. Generally, it is not necessary to use a fibrous panel and any substrate of known weight can be used to measure coat weight for a specific coating process.

In embodiments, the coating includes a spray coating. Spray coating is frequently used to apply coatings onto various substrates. A conventional spray coating process comprises pumping a coating composition through filters into a spray head. In embodiments, the spray head may reciprocate perpendicular to the direction of the movement of a substrate as is known in the art. In spray coating, a coating is created from the spray head in the form of droplets and coats the substrate while leaving uncoated spaces, which can result in an uneven, spotted appearance. In embodiments, spray coating is used to apply a finish coat layer on top of a previously applied primer coat layer applied via curtain coating.

The coating composition used in the spray coating process according to the invention is typically an aqueous coating composition, comprising water, binder(s), filler(s), and any additive(s). In one preferred embodiment, on a relative weight percent basis, the coating composition used in the spray coating process includes a greater amount of latex polymer binder than is present in the coating composition used in the curtain coating process, for example, greater than 50 wt % more, greater than 60 wt % more, or greater than 70 wt % more.

In some embodiments, a coating composition for spray coating includes about 30-65 wt % of water, about 2.5-10 wt % of binder, specifically a latex polymer binder, about 30-65 wt % of filler, and about 0.01-10 wt % of additives. Coating composition components are described by mass of solids where applicable (thus, in the aforementioned liquid coating composition, the latex polymer component is expressed as solids only, and any water that may be present is included with the water component). In embodiments, a coat weight applied by the spray coating is in a range from about 8 g/ft² to about 25 g/ft² and/or about 10 g/ft² to about 22 g/ft².

As used herein, the term “high acoustic” refers to a basemat, optionally finished as a fibrous panel, having a relatively high noise reduction coefficient value, a relatively high ceiling attenuation class rating, or both. For example, in one aspect, the term “high acoustic” refers to the basemats or fibrous panels according to the disclosure having an NRC of at least about 0.75. Sound absorption is typically measured by its Noise Reduction Coefficient (“NRC”) as described in ASTM C423, “Standard Test Method for Sound Absorption and Sound Absorption Coefficients by the Reverberation Method.” The NRC value is a scale representation of the amount of sound energy absorbed upon striking a particular surface, with a NRC value of 0 indicating perfect reflection and a NRC of 1 representing perfect absorption of sound energy. It is determined from an average of four sound absorption coefficients of the particular surface at frequencies of 250 Hz, 500 Hz, 1000 Hz and 2000 Hz, which cover the range of typical human speech. An acoustical panel with an NRC value of 0.6 absorbs 60% of the sound that strikes it and deflects 40% of the sound. Under some circumstances NRC's greater than 1 may be obtained, but this is an artifact of the test method due to diffraction/edge to area effects. In laboratory test of materials in a laboratory per ASTM C423, only the face of the sample is exposed to the sound energy, as would be the case in a typical installation. In embodiments, the high acoustic basemats or fibrous panels of the disclosure can have an NRC of at least about 0.75, for example about 0.75 to about 0.95, about 0.75 to about 0.90, about 0.80 to about 0.90, or about 0.80 to about 0.85.

In another aspect, the term “high acoustic” refers to the basemats or fibrous panels according to the disclosure having a CAC of at least about 35. The Ceiling Attenuation Class (CAC) rating quantifies how much sound is lost when it is transmitted through the ceiling of one room into an adjacent room through a common plenum. A higher CAC rating indicates that the ceiling system allows less sound transmission. The CAC is measured using the test standard ASTM E 1414-16, in which the sound levels are measured in the source room and an adjacent room. In embodiments, the basemats or fibrous panels of the disclosure can have a CAC rating of at least about 30, for example about 35, about 40, about 45, or about 50, for example, between about 30 and about 50, or between about 35 and about 45.

### EXAMPLES

### Example 1—Preparation and Evaluation of Basemat

A basemat according to the invention was made on a wet felt machine using the formulation provided in Table 1.

TABLE 1
Basemat Composition

| Component | Amount (wt %) |
|---|---|
| Mineral wool | 75.5 |
| Perlite | 10 |
| Paper fiber | 3.0 |
| Starch | 10 |
| Latex | 1.0 |
| Gypsum | 0.5 |

The basemat was grinded, laminated with a fiberglass veil, and then coated, via curtain coating followed by spray coating, on the facing side of the basemat. The backing side of the basemat was coated with a solution comprising about 12 g/ft² of clay. The NRC of the finished fibrous panel was determined to be 0.75. The CAC rating of the finished fibrous panel was determined to be 35. The density of the basemat is about 10.3 pcf.

### Example 2—Evaluation of Cellulose Amounts in Basemats

To evaluate lab-scale samples, the aqueous slurry is provided to a Tappi former, an apparatus which similarly processes aqueous slurries to form basemats, albeit on a smaller scale, to the known Fourdinier-type forming machine previously described herein.

Five lab ceiling tiles were made. The five ceiling tiles contained varied amounts of cellulosic fiber (in the form of recycled newsprint) ranging from 0 wt % to 10 wt %. The wet strength and cuttability of the lab ceiling tile, together with detailed formulations used to make the ceiling tiles are shown in Table 2.

TABLE 2
Effect of Cellulose on Wet Strength and Cuttability

| Component | Tile 1 | Tile 2 | Tile 3 | Tile 4 | Tile 5 |
|---|---|---|---|---|---|
| Mineral wool (wt %) | 78.0 | 77.0 | 75.0 | 73.0 | 68.0 |
| Perlite (wt %) | 10.0 | 10.0 | 10.0 | 10.0 | 10.0 |
| Cellulosic fiber (wt %) | 0 | 1.0 | 3.0 | 5.0 | 10.0 |
| Starch (wt %) | 10.0 | 10.0 | 10.0 | 10.0 | 10.0 |
| Latex (wt %) | 1.0 | 1.0 | 1.0 | 1.0 | 1.0 |
| Gypsum (wt %) | 1.0 | 1.0 | 1.0 | 1.0 | 1.0 |
| Wet strength (lbf) | 1.20 | 1.36 | 1.59 | 1.71 | 2.02 |
| Cutting max load (lbf) | 8.67 | 9.32 | 9.79 | 10.94 | 17.64 |
| Cuttability rating | 10 | 10 | 10 | 9 | 7 |

From the data in Table 2, it can be seen that the concentration of cellulosic fiber s critical for providing sufficient wet strength (at least about 1.35 lbf) while maintaining advantageous processability characteristics. As can be seen from the foregoing, an unexpected and surprising improvement in wet strength of greater than 13% is provided when as little as 1 wt % cellulosic fiber is included in the basemat composition. Further, wet strength even further surprisingly improved by over 32% when 3 wt % cellulosic fiber is included, without proportionally increasing the cuttability of the formed basemats. At 1% and 3% cellulosic fiber, the cuttability of the ceiling tile is acceptable and increased by less than 8% and 13%, respectively, relative to the basemat formed without any cellulosic fiber. However, at 5% cellulosic fiber, the cuttability deteriorated significantly (increasing by over 26% relative to the basemat formed without any cellulosic fiber), and became much worse at 10% paper fiber (increasing by over 100% relative to the basemat formed without any cellulosic fiber) confirming the particularly surprising and advantageous balance of wet strength and processability that we attribute to a basemat comprising 1 wt %-3 wt % cellulosic fiber and over 70 wt. % mineral wool.

1. A basemat for a fibrous panel, comprising:
a mineral wool present in an amount of at least about 60 wt %, based on the total weight of the basemat;
a mineral filler;
a cellulose present in an amount of about 1 wt % to about 3 wt %, based on the total weight of the basemat; and,
a binder,
wherein the basemat has a backing side and a facing side.

2. The basemat of claim 1, wherein the mineral wool is present in an amount of about 60 wt % to about 95 wt %, based on the total weight of the basemat

3. The basemat of claim 1, wherein the mineral filler is chosen from one or more mineral fillers in the group of a clay, a perlite, and a vermiculite.

4. The basemat of claim 4, wherein the mineral filler is present in an amount of about 5 wt % to about 25 wt %, based on the total weight of the basemat.

5. The basemat of claim 1, wherein the cellulose comprises a paper fiber.

6. The basemat of claim 1, wherein the binder is chosen from one or more binders in the group of a starch, a latex, and a reconstituted paper product.

7. The basemat of claim 6, wherein the binder comprises a starch and a latex.

8. The basemat of claim 1, wherein the binder is present in an amount of about 5 wt % to about 20 wt %, based on the total weight of the basemat.

9. The basemat of claim 1, wherein the basemat has a density of less than about 15 pounds per cubic foot (pcf).

10. The basemat of claim 1, wherein the basemat has a density of about 10 pcf to about 12 pcf.

11. The basemat of claim 1, wherein:
the mineral wool is present in an amount of about 65 wt % to about 85 wt %, based on the total weight of the basemat;
the mineral filler comprises perlite and is present in an amount of about 8 wt % to about 15 wt %, based on the total weight of the basemat;
the cellulose comprises paper fiber; and,
the binder comprises starch and latex and is present in an amount of about 8 wt % to about 15 wt %, based on the total weight of the basemat,
wherein the starch and the latex are present in a weight ratio of about 7:1 to about 12:1.

12. A fibrous panel comprising:
the basemat of claim 1; and,
a porous veil having a first surface and a second surface, wherein the first surface is in contact with the facing side of the basemat.

13. The fibrous panel of claim 12, wherein the porous veil comprises a nonwoven fiberglass or a fiberglass blended material.

14. The fibrous panel of claim 12, wherein the porous veil is laminated to the basemat.

15. The fibrous panel of claim 12, further comprising a decorative coating on the second surface of the porous veil.

16. The fibrous panel of claim 13, further comprising a back coating on the backing surface of the basemat.

17. The fibrous panel of claim 13, having a noise reduction coefficient (NRC) of at least about 0.75.

18. The fibrous panel of claim 13, having a ceiling attenuation class (CAC) of at least about 35.
